(19) United States
(12) Patent Application Publication
(10) Pub. No.: US 2011/0016022 A1
(43) Pub. Date: Jan. 20, 2011

(54) METHOD AND SYSTEM FOR SALE OF DOMAIN NAMES

(75) Inventors: Tarik R. Essawi, Leesburg, VA (US); Srikanth Veramachneni, South Riding, VA (US); Will Shorter, Sterling, VA (US); Pat Kane, Ashbum, VA (US)

Correspondence Address: TOWNSEND AND TOWNSEND AND CREW LLP, TWO EMBARCADERO CENTER, 8TH FLOOR, SAN FRANCISCO, CA, 94111-3834, US

(73) Assignee: VeriSign, Inc., Mountain View, CA (US)

(21) Appl. No.: 12/504,396

(22) Filed: Jul. 16, 2009

(51) Int. Cl. G06Q 30/00; G06Q 50/00; G06Q 10/00; G06F 15/16

(52) U.S. Cl. 705/26.25; 705/34; 705/400; 709/206

(57) ABSTRACT

A method of determining a multi-year renewal price for an expiring domain name includes setting a first selling price for the expiring domain name and determining that a first period of time has elapsed. The method also includes setting a second selling price for the expiring domain name. The second selling price is less than the first selling price. The method further includes determining the multi-year renewal price. A price for a first year is equal to the second selling price and a price for a second year is greater than the second selling price and less than or equal to the first selling price.

### BACKGROUND OF THE INVENTION

The Domain Name System (DNS) is a hierarchical naming system for computers, services, or any resource participating in the internet. Using DNS, it is possible to associate various information with domain names assigned to internet participants. The analogy has been made that the Domain Name System serves as the “phone book” for the internet by translating human-friendly computer hostnames into IP addresses.

Domain name registration is conducted under a Shared Registration System (SRS), which was created by Network Solutions, Inc. in 1999 to provide a registry through which multiple, globally diverse registrars could register domain names. The term “registry” refers to the entity responsible for managing allocation of domain names within a particular name space, such as a top level domain (TLD). VeriSign, Inc. is currently the largest registry in the world, managing over 50 million digital identities associated with the .com, .org, and .edu TLDs.

A registrar is an entity having the authority to add names to the registry. Thus, entities that wish to register a domain name (a registrant) do so through a registrar, which in turn registers the desired domain name with the appropriate registry. Many registrars exist and provide users with the ability to register a domain name in many different TLDs. The overall registration system, including the multiple registries, is overseen by the Internet Corporation for Assigned Names and Numbers (ICANN).

Domain names are registered for a predetermined period. At the expiration of the predetermined period, the domain name will enter a redemption period in which the registrant can renew the domain name for an additional period. Many domain names, particularly of companies, are renewed in order to maintain continuity of ownership. However, if the registrant does not renew the domain name during the redemption period, the domain name will enter the PENDINGDELETE period and be purged from the registry database after five calendar days. Domain names that are not renewed may be referred to as expiring domain names.

A number of different companies provide lists of domain names that are expiring and enable a registrant to purchase these expiring domain names. Some websites provide search tools to enable a potential registrant to find expiring domain names with particular characteristics. Once found, the domain names are available for purchase at stated prices or through auctions. Despite the offerings of domain names available through existing companies and websites, there is a need in the art for improved methods and systems for setting selling prices for domain names.

### SUMMARY OF THE INVENTION

According to the present invention, domain name registrations systems are provided. More specifically, the present invention relates to methods and systems for pricing domain names to increase renewal rates. Merely by way of example, the invention has been applied to methods and systems for discounting the renewal price for expiring domain names on their day of expiration. The methods and techniques can be applied to other applications as well.

According to an embodiment of the present invention, a method of determining a multi-year renewal price for an expiring domain name is provided. The method includes setting a first selling price for the expiring domain name and determining that a first period of time has elapsed. The method also includes setting a second selling price for the expiring domain name. The second selling price is less than the first selling price. The method further includes determining the multi-year renewal price. A price for a first year is equal to the second selling price and a price for a second year is greater than the second selling price and less than or equal to the first selling price.

According to another embodiment of the present invention, a method of setting a selling price for a domain name is provided. The method includes setting an initial selling price for the domain name and determining that a first period of time has elapsed. The method also includes reducing the selling price to a subsequent selling price less than the initial selling price and selling the domain name to a registrar. Selling the domain name to the registrar includes charging the registrar an amount equal to the subsequent selling price for a first year and charging the registrar an amount higher than the subsequent selling price for a subsequent year.

According to a specific embodiment of the present invention, a computer-readable medium storing a plurality of instructions for controlling a data processor to set a selling price for a domain name is provided. The plurality of instructions include instructions that cause the data processor to set an initial selling price for the domain name and instructions that cause the data processor to determine that a first period of time has elapsed. The plurality of instructions also include instructions that cause the data processor to reduce the selling price to a subsequent selling price less than the initial selling price and instructions that cause the data processor to sell the domain name to a registrar. Selling the domain name to the registrar includes charging the registrar an amount equal to the subsequent selling price for a first year and charging the registrar an amount higher than the subsequent selling price for a subsequent year.

Many benefits are achieved by way of the present invention over conventional techniques. For example, embodiments of the present invention increase the renewal rate of expiring domain names, thereby increasing revenues for the registry. Moreover, embodiments of the present invention provide discounted prices for domain names with less consumer interest, thereby more closely matching the price registrars are willing to pay for domain names to the supply of these domain names. Furthermore, embodiments of the present invention provide a system in which names that were previously registered are more likely to be purchased by another registrar. Since the name will remain in existence, users who had previously gone to the site will still have the name resolved and results returned when they return to the site, rather than receiving a page not found error. These and other embodiments of the invention along with many of its advantages and features are described in more detail in conjunction with the text below and attached figures.

### BRIEF DESCRIPTION OF THE DRAWINGS

FIG. 1 is a schedule for pricing domain names according to an embodiment of the present invention;

FIG. 2 is an example of a daily business report according to an embodiment of the present invention;

FIG. 3 is an example of a detailed daily business report according to an embodiment of the present invention;

FIG. 4 is an example of a detailed daily registrar report according to an embodiment of the present invention;

FIG. 5 is an example of a monthly finance report according to an embodiment of the present invention;

FIG. 6 is an example of a monthly registrar report according to an embodiment of the present invention;

FIG. 7 is a simplified process flow for a method of registering a domain name according to a first embodiment of the present invention;

FIG. 8 is a simplified process flow for a method of registering a domain name according to a second embodiment of the present invention;

FIG. 9 is a simplified process flow for a method of registering and deleting a domain name according to a third embodiment of the present invention;

FIG. 10 is a simplified process flow for a method of registering and deleting a domain name according to a fourth embodiment of the present invention; and

FIG. 11 is a simplified process flow for a method of registering a domain name according to a fifth embodiment of the present invention.

### DETAILED DESCRIPTION OF SPECIFIC EMBODIMENTS

According to embodiments of the present invention, methods and systems for offering promotional discounts for domain names exiting the PENDINGDELETE period (i.e., after a predetermined time in the PENDINGDELETE status). The inventors have determined that of the thousands of domain names deleted per day, the renewal rate is less than 10%. Utilizing embodiments of the present invention, this renewal rate can potentially be increased. The implementations described herein are illustrated in the context of the .COM and .NET top level domains (TLDs), but it will be appreciated that the present invention is not limited to these particular TLDs and has applicability to other TLDs. Moreover, although these implantations are illustrated in the context of ASCII domain names, the present invention is not limited to only ASCII domain names. One of ordinary skill in the art would recognize many variations, modifications, and alternatives.

As described more fully throughout the present specification, the methods and systems of the present invention are applicable to all domain names in the PENDINGDELETE batch and applicable to all registrars. Like domain names purchased through other programs, grace period refunds will be given to domain names purchased through this discount program. One benefit provided by embodiments of the present invention is that practice of the invention do not require any changes to the online transaction processing (OLTP) system.

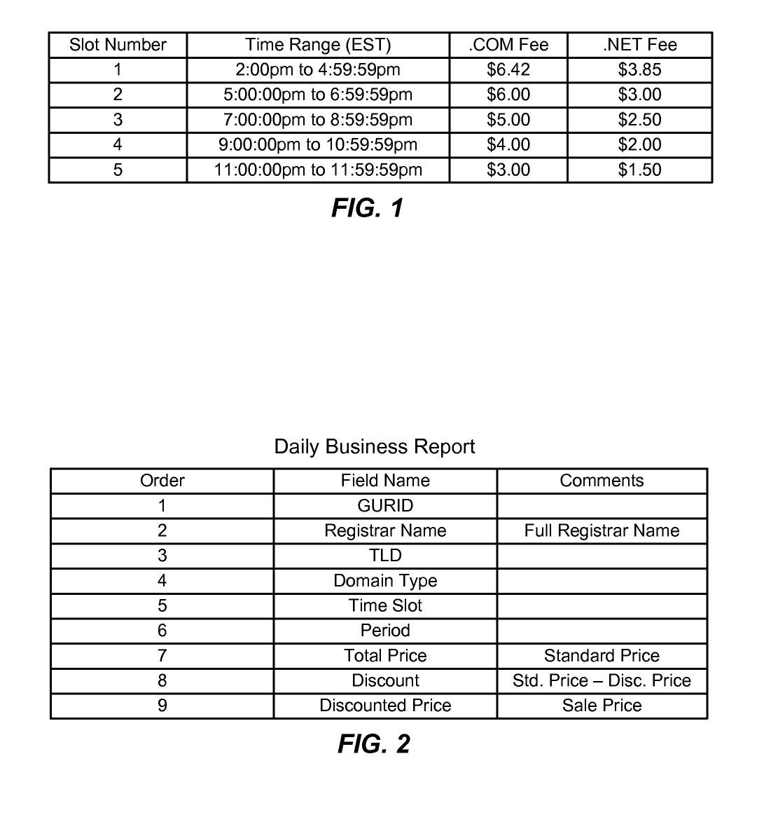

FIG. 1 is a schedule for pricing domain names according to an embodiment of the present invention. The domain names that are deleted on a daily basis are released at the normally scheduled time of 2:00 p.m. EST. As shown in FIG. 1, during a first time slot or period (e.g., from 2:00-4:59:59 p.m.), the price of the domain name is set at the full price for the domain name (e.g., $6.42 for a .COM domain name). The first time slot illustrated in FIG. 1 is a period of just under three hours, although this particular value is not required by the present invention. Other suitable time periods are included within the scope of the present invention.

After expiration of the first time period, the price of the domain name is discounted by a predetermined amount (e.g., $0.42 for a .COM domain name) in order to set the price of the domain name at a second price (e.g., $6.00 for a .COM domain name). The second price is effective during a second time slot or period, which extends for a predetermined period of time. In the embodiment illustrated in FIG. 1, the second time slot is approximately two hours, expiring at 6:59:59 p.m. Purchase of an expiring domain name during the second time slot (e.g., between 5:00:00 and 6:59:59 p.m.) will thus cost the registrar 42 cents less than in the initial first time period.

As the day progresses towards midnight, a predetermined number of additional time periods are provided in which the price continues to be discounted by predetermined amounts. In the example illustrated in FIG. 1, three additional time slots (i.e., time periods 3, 4, and 5) are utilized to discount the price by an additional dollar. Thus, to purchase an expiring domain name in the fourth time slot will cost $4.00 rather than the full price of $6.42.

Although particular time slots or periods and discounts are illustrated in FIG. 1, these particular time periods and prices are not required by the present invention. In other embodiments, a different number of time slots such as ten time slots, each an hour in length are used during the period from 2:00 p.m. until midnight. Moreover, the final discounted price of $3.00 is illustrated, but this is not required by the present invention since other suitable prices can be used. Additionally, although a linear discounting of the price is illustrated (i.e., one dollar per two hour period for time slots 2-4), this is not required by the present invention and other discount schedules can be utilized. One of ordinary skill in the art would recognize many variations, modifications, and alternatives.

By decreasing the price of the domain name as a function of time, registrars or registrants who might not have purchased a particular domain name at full price may desire to purchase an expiring domain name at a reduced price. In addition to the fees illustrated in FIG. 1, other fees can be applied as appropriate to the particular domain name, such as an additional ICANN fee of $0.75. If the domain name is not purchased during the promotion period, the domain name will expire and will be offered at the full price during subsequent times, for example, the next day. In order to change the prices during the various promotion periods, the standard interfaces are utilized to set the various prices.

Referring once again to FIG. 1, during the first time slot, registrars will be charged the full price for registering an expiring domain name during the first time period. Registrars who register the domain name and then subsequently delete the domain name during one of the discounted time slots will be eligible for a grace period refund, but the domain will no longer be eligible at any level of discount.

During the discounted time periods (e.g., time slots 2-5), registrars who register an expiring domain name during the discounted time periods will be charged a reduced price based on the price schedule or matrix established for the promotion, an example of which is given in FIG. 1. Registrars who register the domain name during one of the discounted time slots and delete the domain name in the subsequent time slot, will get the refund, but the domain will no longer be eligible at any level of discount.

According to an embodiment of the present invention, a price check feature is provided in which a registrar can request and receive the current price of a domain name and the expiration time associated with the current price. In an embodiment, this price check feature is implemented as an extension to the EPP information (“info”) command. The registrar, as part of the info command, passes in a flag indicating the request for the price check. In response, the current price and the expiration time for the current price are returned to the registrar. As an example, if a registrar requests the price check at 8:00 p.m., the price of $5.00 for a .COM domain name and the expiration time of 8:59:59 p.m. would be returned. Thus, the registrars are able to request and receive current discounted pricing for domain names included in the promotion. This price check feature is particularly useful when the expiration times are non-uniformly distributed between the beginning time and the ending time of the discount period.

An aspect of the present invention is that discounts only apply to the first year of registration. Any subsequent years added will be charged at full price. Thus, the discounted prices illustrated in FIG. 1 are only applied during a predetermined promotional period (e.g., the first year) and only for Domain Creates. These discounted prices are not carried over to future renewals. The application of discounts to only the first year of registration is a differentiator between the pricing schedule illustrated in FIG. 1 and discounts sometimes available on other products. In contrast with conventional sales in which prices are discounted as a function of time and the discounted price is applicable to all articles for sale, the character of domain names, which can be renewed for terms of varying length, enables a bifurcation of the annual renewal rates between the first year and subsequent years.

In order to account for discounts given to registrars registering expiring domain names at reduced prices, several reports are generated according to embodiments of the present invention. These reports are discussed in detail below.

FIG. 2 is an example of a daily business report according to an embodiment of the present invention. Also referred to as a Daily Business Summary Report, this report is a daily report that reports month-to-date summary data of the transactions that take place on the previous day. This report can be used to perform a variety of analysis tasks.

As illustrated in FIG. 2, the daily business report includes a record for each domain name purchased. The set of entries include the globally unique registrar ID (GURID), the name of the registrar, the TLD for which the registrar is registering the domain name, the domain type, the time period in which the domain was purchased, the period for which the domain was purchased, the total price of the expiring domain name, the discount amount, and the discounted price (i.e., the total price less the discount amount). The total price is the standard price for the domain name, $6.42 in the embodiments described herein.

The daily business report can be sorted by registrar name and TLD. In an embodiment, the daily business report is output as a text file with pipe delimited records although other suitable formats can be used. The report is run daily before noon to capture all expiring domain names sold on the previous day.

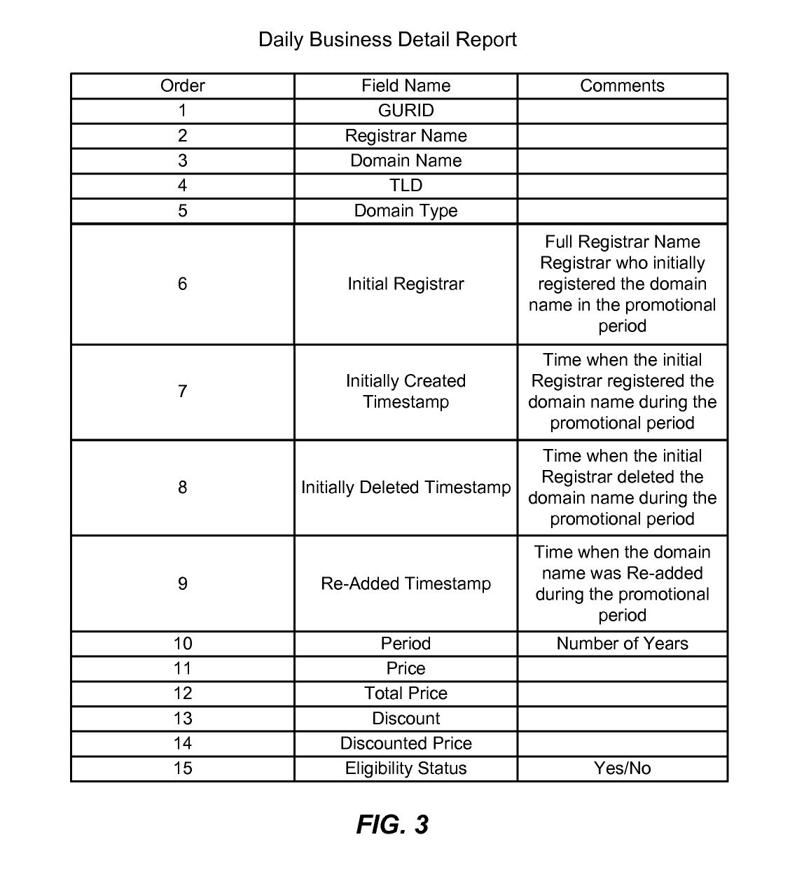

FIG. 3 is an example of a detailed daily business report according to an embodiment of the present invention. Also referred to as the Daily Business Detail Report, this report shows all registrar's detailed activity relating to the promotional period transactions from the previous day.

The Daily Business Detail Report includes records that include the GURID, the full name of the registrar, the domain name purchased, the TLD for which the domain name was purchased, the domain type, the full name of the initial registrar, that is, the registrar who initially registered the domain name in the promotional period, the Initially Created Timestamp, which is the time when the initial registrar registered the domain name during the promotional period, the Initially Deleted Timestamp, which is the time when the initial registrar deleted the domain name during the promotional period, and the Re-Added Timestamp, which is the time when the domain name was re-added during the promotional period. If the domain name was not deleted or re-added during the promotional period, then the entries for the Initially Deleted Timestamp and the Re-Added Timestamp are blank.

Each Daily Business Detail Report also includes the period (in years) for which the domain name was renewed, the price, the total price, the discount, the discounted price, and an indicator of the eligibility status. The indicator of the eligibility status will prevent a registrar from purchasing a domain name early in the promotion period, holding the domain name until late in the promotion period, and then deleting and re-adding the domain name at the lower price associated with the later period in the promotion. Thus, once a domain name is purchased during the promotion period, the indicator of eligibility status will be changed to prevent the registrar who purchased the domain name, or another registrar, from performing actions that would effectively reduce the price of the domain name later during the promotion period.

In an embodiment, the Daily Business Detail Report is sorted by the following field elements: Registrar Name, TLD, and domain name. The Daily Business Detail Report is output as a text file with pipe delimited records although other suitable formats can be used. The report is run daily before noon to capture all expiring domain names sold on the previous day.

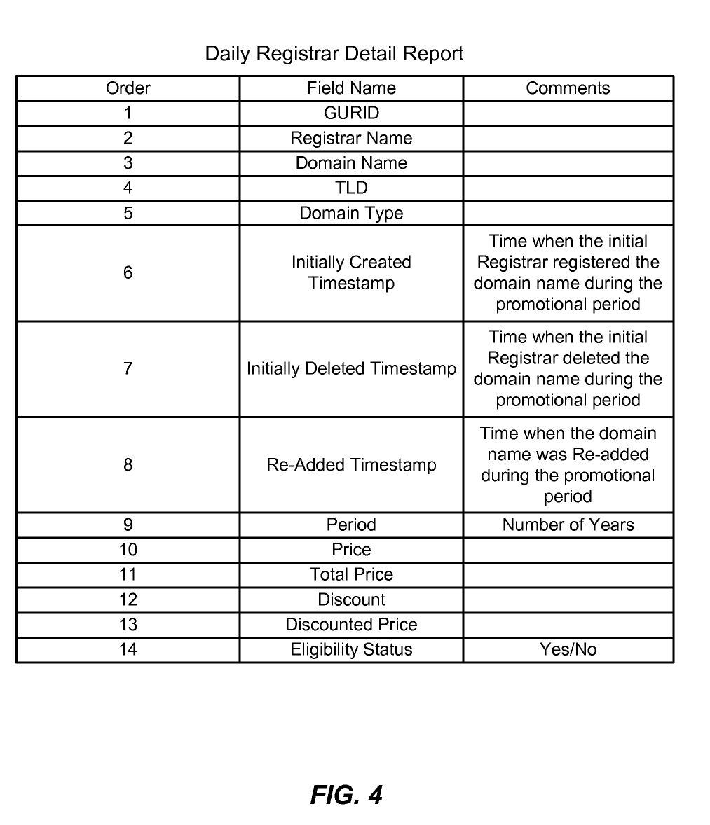

FIG. 4 is an example of a detailed daily registrar report according to an embodiment of the present invention. Also referred to as the Daily Registrar Detail Report, this report is a Daily Report that is posted to the registrar FTP site (e.g., a registrar specific folder on the FTP server for each registrar). This report shows the registrar's detailed activity related to the registration of discounted domain names from the previous day.

The Daily Registrar Detail Report includes records that include the GURID, the full name of the registrar, the domain name registered, the TLD in which the domain name was registered, and the domain type. The records also include an Initially Created Timestamp, which is the time when the initial registrar registered the domain name during the promotional period, the Initially Deleted Timestamp, which is the time when the initial registrar deleted the domain name during the promotional period, and the Re-Added Timestamp, which is the time when the domain name was re-added during the promotional period. If the domain name was not deleted or re-added during the promotional period, then the entries for the Initially Deleted Timestamp and the Re-Added Timestamp are blank.

The records of the Daily Registrar Detail Report also include the period of registration (in years), the price, the total price, the discount, the discounted price, and the an indicator of the eligibility status.

In an embodiment, the Daily Registrar Detail Report is sorted by the following field elements: TLD and domain name. The Daily Registrar Detail Report is output as a text file with pipe delimited records although other suitable formats can be used. The report is run daily before noon to capture all expiring domain names sold on the previous day.

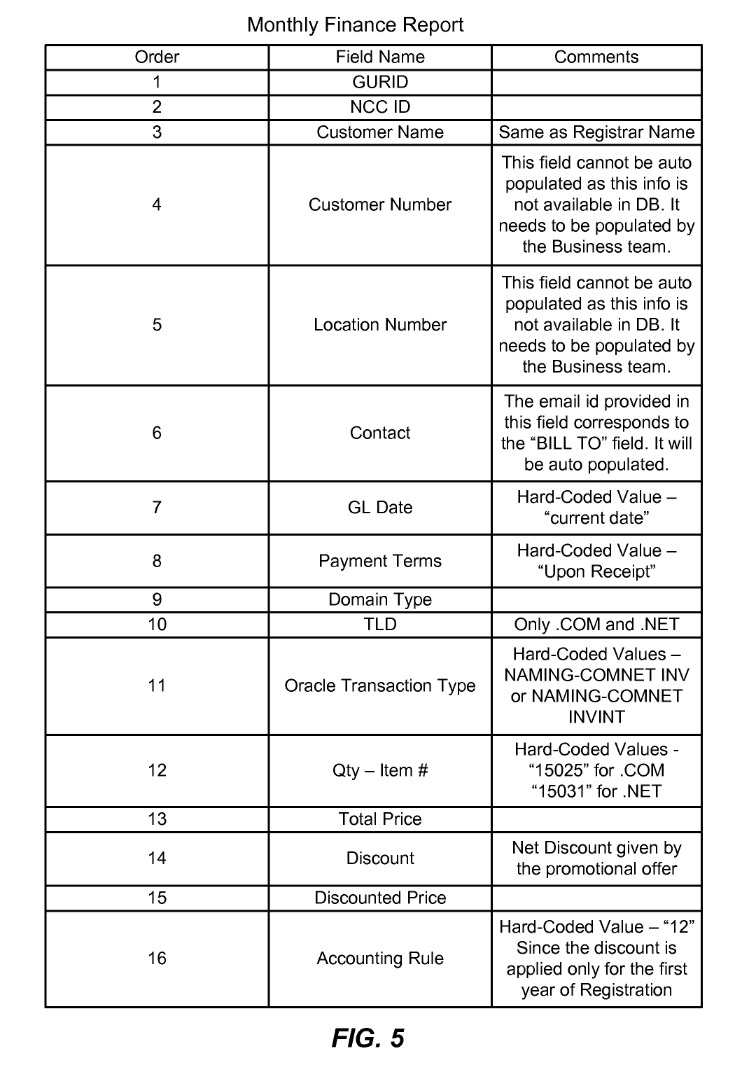

FIG. 5 is an example of a monthly finance report according to an embodiment of the present invention. Also referred to as the Monthly Finance Summary Report, this report shows the total discounts for finance to create credit line items on participating registrars' monthly invoices and credit the appropriate Namestore Customer Console (NCC) account.

The Monthly Finance Summary Report includes records that include the GURID, the NCC ID, the customer name, which is typically the same as the registrar name, and the customer number. The customer number field is not automatically populated in some embodiments as this information is not available in the financial management database. In these embodiments, the customer number field is populated by appropriate personnel (e.g. the business team).

The records also include the location number. The location number field is not automatically populated in some embodiments as this information is not available in the financial management database. In these embodiments, the location number field is populated by appropriate personnel (e.g. the business team). The records additionally include a contact, which is the email address or ID corresponding to the “BILL TO” field in the NCC. The contact information is automatically populated. The records further include the general ledger (GL) date, which is a hard-coded value equal to “Current Date,” the payment terms, which is a hard-coded value equal to “Upon Receipt,” the domain type, the TLD (only .COM and .NET in some particular embodiments), the Oracle transaction type, which is one of two hard-coded values for domestic or international customers: NAMING-COMNET INV or NAMING-COMNET INVINT, the quantity—Item # for billing to the particular product, which is one of two hard-coded values: “15025” for .COM and “15031” for .NET, the total price, the net discount given by the promotional offer, the discounted price (i.e., the total price less the discount), and the accounting rule, which a hard-coded value equal to “12,” since the discount is applied only for the first year of registration.

In an embodiment, the Monthly Finance Summary Report is sorted by the following field elements: Customer Name and TLD. The Monthly Finance Summary Report is output as a text file with pipe delimited records although other suitable formats can be used. The report is run on a monthly basis, typically, the 6^{th} calendar day of each month before noon.

The Monthly Finance Summary Report is one of the mechanisms that is utilized to identify and report the discounted priced to the appropriate accounting systems as described more fully throughout the present specification. In the embodiments described herein, reconciliation of the discounts is performed after purchase using reports such as the Monthly Finance Summary Report. Thus, backend reporting is used to identify the discounted price, reconciliation is performed by a finance department, and all transaction activity is processed in the Auto Batch Pool on in accordance with a per connection policy.

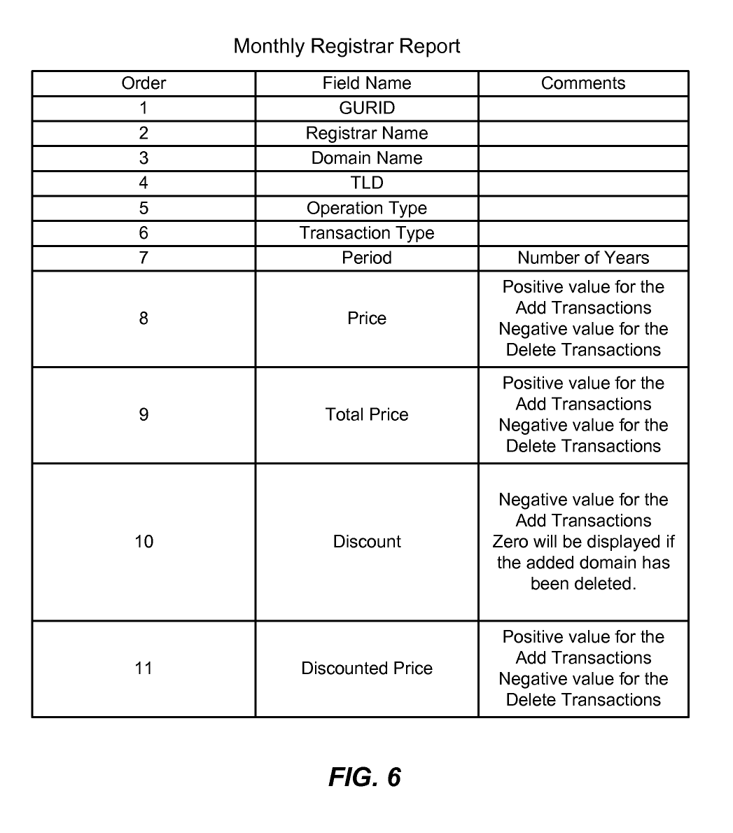

FIG. 6 is an example of a monthly registrar report according to an embodiment of the present invention. Also referred to as the Monthly Registrar Summary Report, this report used by the registrars to reconcile against their invoice. This report shows all the discounted domain names registered and the grace period deletes that were done during the previous month. It will also contain one or more “Totals” line items at the end of the report that will show the aggregated amount charged to the registrar per TLD. These total line items (e.g,. one per TLD—.COM and .NET in an embodiment) will match with the totals (i.e., the Discount fields) that are reported in the Monthly Finance Summary Report discussed above.

The Monthly Registrar Summary Report includes records that include the GURID, the registrar name, the domain name registered, the TLD in which the domain name was registered, the operation type, the transaction date, and the registration period (in years). The records also include the price, which is a positive value for the Add Transactions, and a negative value for the Delete Transactions, the total price, which is a positive value for the Add Transactions and a negative value for the Delete Transactions. The records additionally include the discount, which is a negative value for the Add Transactions. A zero will be displayed if the added domain has been deleted. Additional discussion related to computation of the discount is provided below.

The records further include the discounted price, which is a positive value for the Add Transactions and a negative value for the Delete Transactions. Thus, in embodiments in which discounts are given for the .COM and .NET TLDs, the Monthly Registrar Summary report will provide the registrars with the total discount for .COM and .NET domain names registered during the month.

In an embodiment, the Monthly Registrar Summary Report is sorted by the following field elements: Domain Name, Transaction Date, and TLD. The Monthly Registrar Summary Report is output as a text file with pipe delimited records although other suitable formats can be used. The report is run on a monthly basis, typically, the 6^{th} calendar day of each month before noon.

Examples of how the Add and Delete transactions are accounted for in the reports, for example, the Monthly Registrar Summary Report, are provided below.

As an example, Table 1 shows a registrar making an Add transaction (which has not been deleted within the grace period) for a domain name registration. The transaction is made at 6:00 p.m., thus falling into time slot 2 in FIG. 1.

TABLE 1

| Registrar | | Operation | Period | | Total | | Discounted |
|---|---|---|---|---|---|---|---|
| Name | TLD | Type | (Years) | Price | Price | Discount | Price |
| XYZ | .COM | Add | 2 | $6.42 | $12.84 | −$0.42 | $12.42 |

Net Amt: −$0.42
Total Discount for .COM = −$0.42

As another example, Table 2 shows a registrar making an Add transaction and then a Delete Transaction for a domain name registration. The transactions are made at 6:00 p.m. and 6:15 p.m., thus falling into time slot 2 in FIG. 1.

### Table 2

TABLE 2

| Registrar | | Operation | Period | | Total | | Discounted |
|---|---|---|---|---|---|---|---|
| Name | TLD | Type | (Years) | Price | Price | Discount | Price |
| XYZ | .COM | Add | 2 | $6.42 | $12.84 | 0 | $12.42 |
| XYZ | .COM | Delete | | −$6.42 | −$12.84 | 0 | −$12.84 |

Net Amt: $0.00
Total Discount for .COM = $0.00

The “Total Discount for .COM” shown at the bottom of the Table is the Net Amount of the Discount column in the report. The “Total Discount for .COM” should be validated against the “Discount” field in the Monthly Finance Summary Report. As will be evident to one of skill in the art, these values in these two fields should reconcile with each other.

Table 3 illustrates various use cases in accordance with embodiments of the present invention. The use cases illustrated in Table 3 are associated with registrations in the .COM TLD. However, the present invention is applicable to registrations of domain names in multiple TLDs, including .COM and .NET, and these use cases for registrations in the .COM TLD are merely examples and are not intended to limit the scope of the present invention.

TABLE 3

| Use | | | | | |
|---|---|---|---|---|---|
| Case | | Period | Slot | | |
| Number | Action | (Years) | number | Price | Comments |
| 1 | Registrar 1 | 1 | 2 | $6.00 | Discounted price of $6.00 is |
| | Add | | | | charged. |
| 2 | Registrar 1 | >1 | 2 | $6.00 | Discounted price of $6.00 is |
| | Add | | | | charged for the first year. |
| | | | | | Full price of $6.42/yr is |
| | | | | | charged for the Remaining |
| | | | | | Years. |
| 3 | Registrar 1 | >1 | 2 | $6.00 | Discounted price of $6.00 is |
| | Add and | | | | charged and then refunded for |
| | Delete during | | | | the first year. |
| | grace period | | | | Full price of $6.42/yr is |
| | | | | | charged and then refunded for |
| | | | | | the Remaining Years. |
| 4 | Registrar 1 | 1 | 2 | $6.00 | Discounted price of $6.00 is |
| | Add, | 1 | 2 | | charged and then refunded for |
| | Renew, and | | | | the first year. |
| | Delete during | | | | Full price of $6.42/yr is |
| | grace period | | | | charged and then refunded for |
| | | | | | the Remaining Years. |
| 5 | Registrar 1 | 1 | 2 | $6.00 | Registrar 1: Discounted price |
| | Add and | | | | of $6.00 is charged and then |
| | Delete during | | | | Refunded for the first year. |
| | grace period | | | | |
| | Registrar 2 | 1 | 3 | | Registrar 2: Full price of $6.42 |
| | Re-Add | | | | is charged (Not eligible for |
| | | | | | discounted price since the |
| | | | | | domain name was Re-Added). |

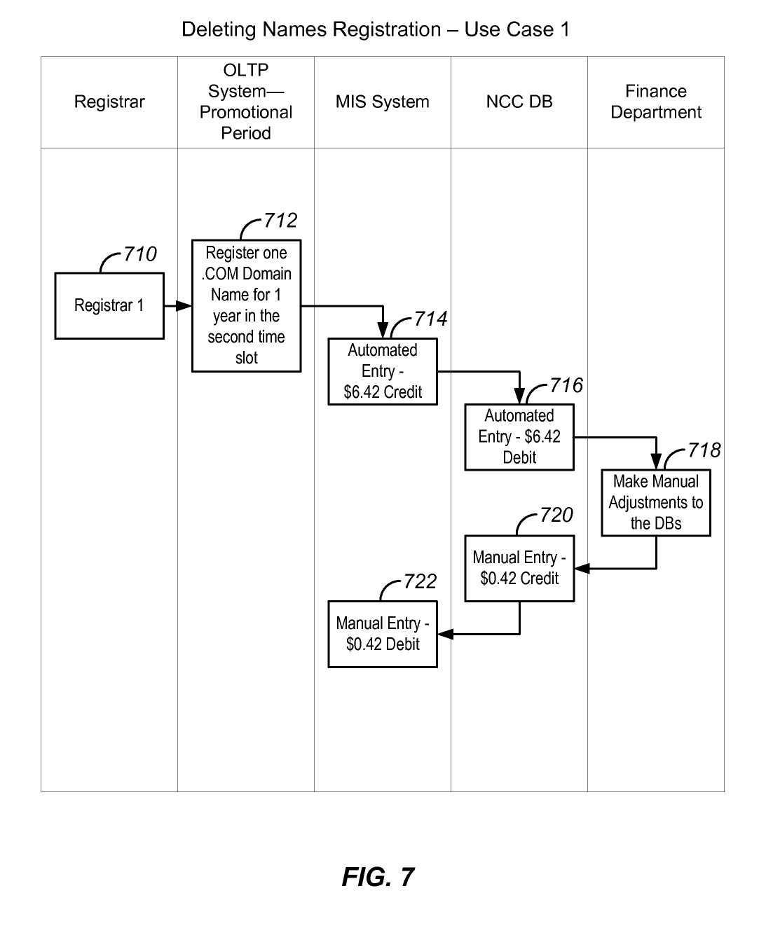

FIG. 7 is a simplified process flow for a method of registering a domain name according to a first embodiment of the present invention. Registrar 1 (710) registers one .COM domain name for one year during the 2^{nd} time slot illustrated in FIG. 1 (712). The discount price that should be charged for this domain name registration is $6.00. In the accounting system (i.e., the backend system), $6.42 is charged against the registrar in the following manner:

$6.42 Credit to the financial management system (714)

$6.42 Debit to the Registrar Account in the NCC DB (716)

In order to credit the promotional discount to the registrar, a manual adjustment is made by the Finance Department (718). This adjustment can be made after the 6^{th} day of the following month based on the information provided in the Monthly Summary Finance Report discussed above. The adjustments are as follows:

$0.42 Debit to the MIS System (720)

$0.42 Credit to the Registrar Account in the NCC DB (722)

Thus, Registrar 1 receives a discounted price of $6.00 for the registered domain name, which is a discount of $0.42 off of the regular price of $6.42.

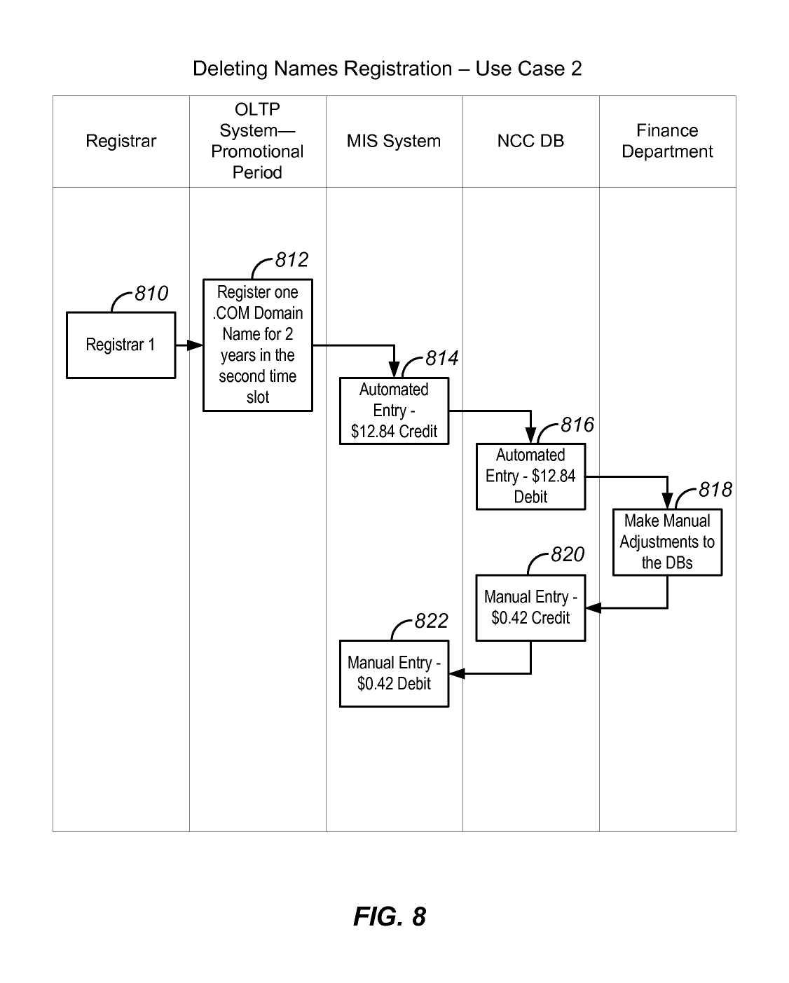

FIG. 8 is a simplified process flow for a method of registering a domain name according to a second embodiment of the present invention. As illustrated in FIG. 8, Registrar 1 (810) registers one .COM domain name for two years during the 2^{nd} time slot (812). The discount price that should be charged for this domain name registration is $12.42 (i.e., $6.00 for the first year and $6.42 for the second year). In the accounting system (i.e., the backend system), $12.84 is charged against the registrar in the following manner:

$12.84 Credit to the financial management system (814)

$12.84 Debit to the Registrar Account in the NCC DB (816)

In order to credit the promotional discount to the registrar, a manual adjustment is made by the Finance Department (818). This adjustment can be made after the 6^{th} day of the following month based on the information provided in the Monthly Summary Finance Report discussed above. The adjustments are as follows:

$0.42 Debit to the financial management system (820)

$0.42 Credit to the Registrar Account in the NCC DB (822)

Thus, Registrar 1 receives a discounted price of $12.42 for the registered domain name, which is a discount of $0.42 off of the regular price of $12.84.

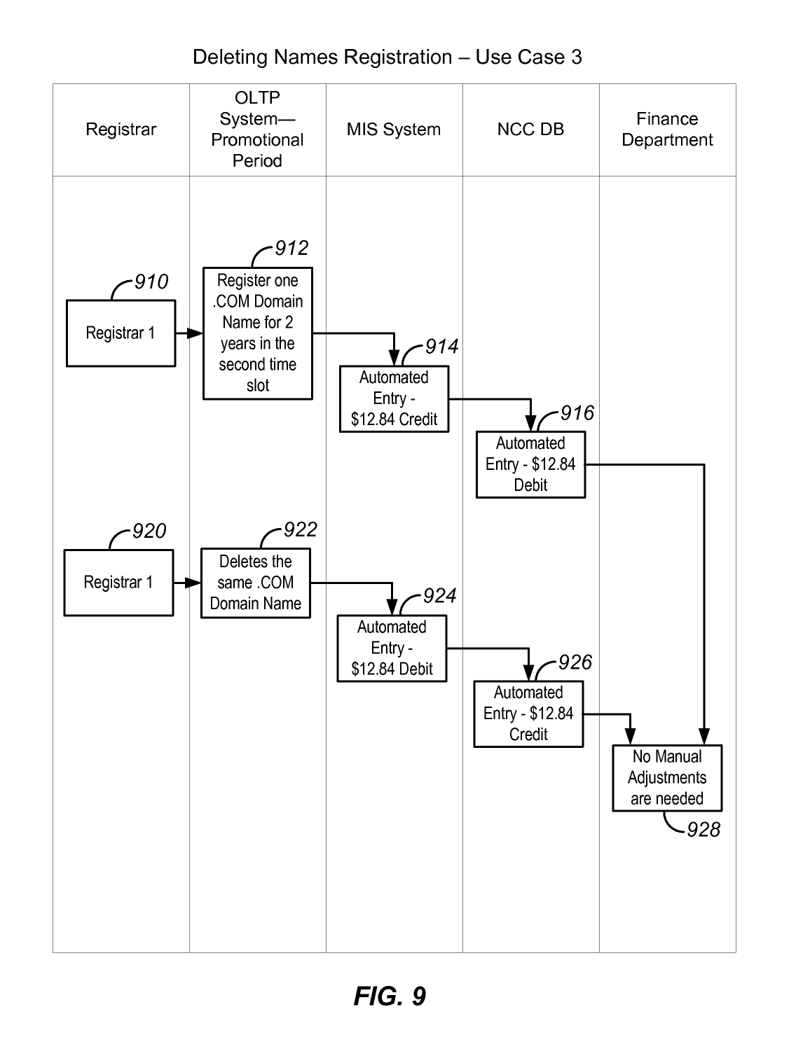

FIG. 9 is a simplified process flow for a method of registering and deleting a domain name according to a third embodiment of the present invention. As illustrated in FIG. 9, Registrar 1 (910) registers one .COM domain name for two years during the 2^{nd} time slot (912). The discount price that should be charged for this domain name registration is $12.42 (i.e., $6.00 for the first year and $6.42 for the second year). In the accounting system (i.e., the backend system), $12.84 is charged against the registrar in the following manner:

$12.84 Credit to the financial management system (914)

$12.84 Debit to the Registrar Account in the NCC DB (916)

Registrar 1 (920) deletes the same .COM domain name during the promotional period (922). The grace period refund of $12.42 (i.e., $6.00 for the first year and $6.42 for the second year) should thus be given to Registrar 1. In the accounting system (i.e., the backend system), $12.84 is refunded to the registrar in the following manner:

$12.84 Debit to the financial management system (924)

$12.84 Credit to the Registrar Account in the NCC DB (926)

Since the transactions nullify each other, no manual adjustments are needed for the use case illustrated in FIG. 9 (928). Thus, the reports for this use case will have zero entries for the Total Price, the Discount, and the Discounted Price associated with Registrar 1.

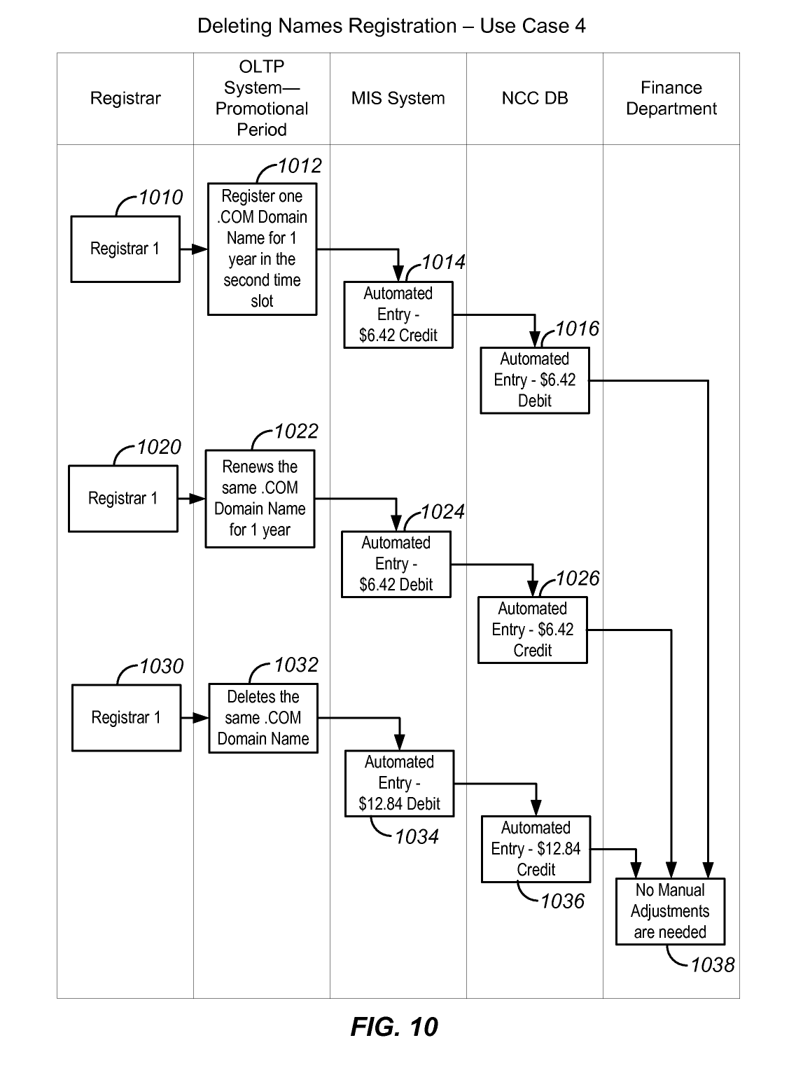

FIG. 10 is a simplified process flow for a method of registering and deleting a domain name according to a fourth embodiment of the present invention. Registrar 1 (1010) registers one .COM domain name for one year during the 2^{nd} time slot (1012). The discount price that should be charged for this domain name registration is $6.00. In the accounting system (i.e., the backend system), $6.42 is charged against the registrar in the following manner:

$6.42 Credit to the financial management system (1014)

$6.42 Debit to the Registrar Account in the NCC DB (1016)

Registrar 1 (1020) subsequently renews the same .COM domain name during the promotional period (1022). The discount price will not be applied to the second year of registration since the discounted price is only applicable to the first year of registration. Thus, the price that should be charged for the second year renewal is the full price of $6.42. In the accounting system (i.e., the backend system), $6.42 is charged against the registrar in the following manner:

$6.42 Credit to the financial management system (1024)

$6.42 Debit to the Registrar Account in the NCC DB (1026)

Registrar 1 (1030) then deletes the same .COM domain name during the promotional period (1032). The grace period refund of $12.42 (i.e., $6.00 for the first year and $6.42 for the second year) should be given to the registrar. In the accounting system (i.e., the backend system), $12.84 is refunded to the registrar in the following manner:

$12.84 Debit to the financial management system (1034)

$12.84 Credit to the Registrar Account in the NCC DB (1036)

Since the transactions nullify each other, no manual adjustments are needed for the use case illustrated in FIG. 10 (1038). Thus, the reports for this use case will have zero entries for the Total Price, the Discount, and the Discounted Price associated with Registrar 1.

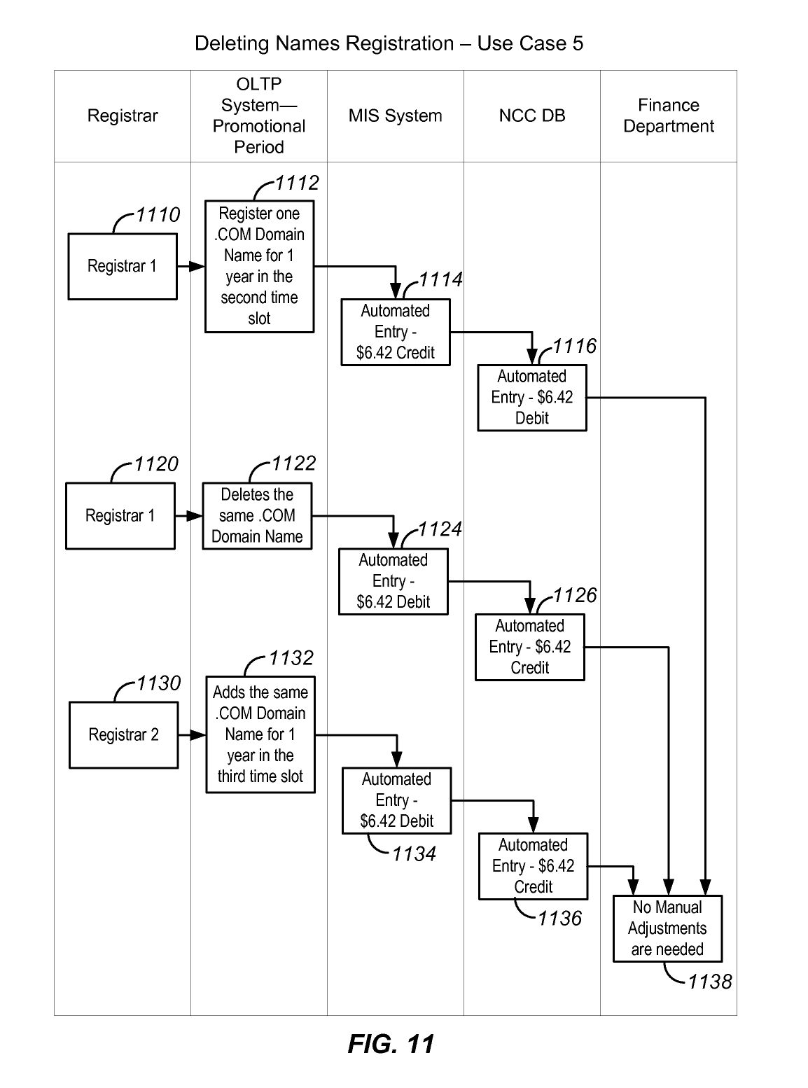

FIG. 11 is a simplified process flow for a method of registering a domain name according to a fifth embodiment of the present invention. As illustrated in FIG. 11, Registrar 1 (1110) registers one .COM domain name for one year during the 2^{nd} time slot (1112). The discount price that should be charged for this domain name registration is $6.00. In the accounting system (i.e., the backend system), $6.42 is charged against the registrar in the following manner:

$6.42 Credit to the financial management system (1114)

$6.42 Debit to the Registrar Account in the NCC DB (1116)

Registrar 1 (1120) subsequently deletes the same .COM domain name during the promotional period. The grace period refund of $6.00 should thus be given to the registrar. In the accounting system (i.e., the backend system), $6.42 is refunded to the registrar in the following manner:

$6.42 Debit to the financial management system (924)

$6.42 Credit to the Registrar Account in the NCC DB (926)

Another registrar, Registrar 2 (1130), registers the same .COM domain name during the 3^{rd} time slot. Registrar 2 is not eligible for the discount price since the domain had already been registered and deleted by another registrar (i.e., Registrar 1) during the promotional period. In the accounting system (i.e., the backend system), the full price of $6.42 is charged against Registrar 2 in the following manner:

$6.42 Credit to the financial management system (1134)

$6.42 Debit to the Registrar Account in the NCC DB (1136)

Since the transactions nullify each other, no manual adjustments are needed for the use case illustrated in FIG. 11 (1138). Thus, the reports for this use case will have zero entries for the Total Price, the Discount, and the Discounted Price associated with Registrar 1. The entries for Registrar 2 will be Total Price: $6.42, Discount: $0.00, and Discounted Price $6.42.

It is understood that the methods described herein can be performed using systems, processors, engines, and the like, that may be included in one or more general purpose processors configured to execute instructions and data. Thus, the various processes illustrated in FIGS. 7-11 can be performed by processors adapted to the various tasks and coupled to one or more memories that store instructions adapted to be executed by the processor. The processor can be a general purpose microprocessor configured to execute instructions and data, such as a Pentium processor manufactured by the Intel Corporation of Santa Clara, Calif. It can also be an Application Specific Integrated Circuit (ASIC) that embodies at least part of the instructions for performing the method in accordance with the present invention in software, firmware and/or hardware. As an example, such processors include dedicated circuitry, ASICs, combinatorial logic, other programmable processors, combinations thereof, and the like. The memory can be any device capable of storing digital information, such as RAM, flash memory, a hard disk, a CD, etc. Thus, processors as provided herein are defined broadly and include, but are not limited to processors performing functions related to selling domain names. The processes described herein can be implemented using computer-readable medium storing a plurality of instructions for performing at least a portion of the methods included within the scope of the present invention.

It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A method of determining a multi-year renewal price for an expiring domain name, the method comprising:
setting a first selling price for the expiring domain name;
determining that a first period of time has elapsed;
setting a second selling price for the expiring domain name, wherein the second selling price is less than the first selling price; and
determining the multi-year renewal price, wherein a price for a first year is equal to the second selling price and a price for a second year is greater than the second selling price and less than or equal to the first selling price.

2. The method of claim 1 wherein the price for the second year is equal to the first selling price.

3. The method of claim 1 further comprising:
transmitting the first selling price to one or more registrars using a communications network; and
transmitting the second selling price to the one or more registrars using the communications network.

4. The method of claim 1 wherein the first period of time is less than three hours.

5. The method of claim 1 further comprising receiving an order to purchase the expiring domain name from a registrar, wherein the order is received over a communications network.

6. The method of claim 5 wherein the communications network comprises the internet.

7. The method of claim 1 further comprising transmitting a message including a difference between the first selling price and the second selling price to a server.

8. The method of claim 1 further comprising:
receiving a request for the second selling price from a registrar; and
transmitting the second selling price and an expiration time for the second selling price to the registrar.

9. The method of claim 7 wherein the server comprises accounting software.

10. The method of claim 1 wherein the expiring domain name is in a PENDINGDELETE status.

11. A method of setting a selling price for a domain name, the method comprising:
setting an initial selling price for the domain name;
determining that a first period of time has elapsed;
reducing the selling price to a subsequent selling price less than the initial selling price; and
selling the domain name to a registrar, wherein selling the domain name to the registrar comprises:
charging the registrar an amount equal to the subsequent selling price for a first year; and
charging the registrar an amount higher than the subsequent selling price for a subsequent year.

12. The method of claim 11 wherein the amount higher than the subsequent selling price is less than or equal to the initial selling price.

13. The method of claim 11 further comprising:
determining that a second period of time has elapsed;
reducing the selling price to a second subsequent selling price less than the subsequent selling price; and
selling the domain name to the registrar, wherein the registrar is charged the second subsequent selling price for the first year rather than the subsequent selling price.

14. The method of claim 13 wherein the second period of time is less than three hours.

15. The method of claim 13 further comprising:
transmitting the subsequent selling price to one or more registrars using a communications network; and
transmitting the second subsequent selling price to the one or more registrars using the communications network.

16. The method of claim 11 wherein the first period of time is less than three hours.

17. The method of claim 11 further comprising receiving an order to purchase the domain name from the registrar, wherein the order is received over a communications network.

18. The method of claim 17 wherein the communications network comprises the internet.

19. The method of claim 11 further comprising transmitting a message including a difference between the initial selling price and the subsequent selling price to a server.

20. The method of claim 19 wherein the server comprises accounting software.

21. The method of claim 11 wherein the domain name is in a PENDINGDELETE status.

22. The method of claim 11 wherein a renewal price for the domain name is equal to the initial selling price.

23. The method of claim 11 wherein the subsequent year is a second year.

24. A computer-readable medium storing a plurality of instructions for controlling a data processor to set a selling price for a domain name, the plurality of instructions comprising:
instructions that cause the data processor to set an initial selling price for the domain name;
instructions that cause the data processor to determine that a first period of time has elapsed;
instructions that cause the data processor to reduce the selling price to a subsequent selling price less than the initial selling price; and
instructions that cause the data processor to sell the domain name to a registrar, wherein selling the domain name to the registrar comprises:
charging the registrar an amount equal to the subsequent selling price for a first year; and
charging the registrar an amount higher than the subsequent selling price for a subsequent year.

25. The computer-readable medium of claim 24 wherein the amount higher than the subsequent selling price is less than or equal to the initial selling price.

26. The computer-readable medium of claim 24 further comprising:
instructions that cause the data processor to determine that a second period of time has elapsed;
instructions that cause the data processor to reduce the selling price to a second subsequent selling price less than the subsequent selling price; and
instructions that cause the data processor to sell the domain name to the registrar, wherein the registrar is charged the second subsequent selling price for the first year rather than the subsequent selling price.

27. The computer-readable medium of claim 26 further comprising:
transmitting the subsequent selling price to one or more registrars using a communications network; and
transmitting the second subsequent selling price to the one or more registrars using the communications network.

28. The computer-readable medium of claim 24 further comprising receiving an order to purchase the domain name from the registrar, wherein the order is received over a communications network.

29. The computer-readable medium of claim 24 further comprising transmitting a message including a difference between the initial selling price and the subsequent selling price to a server.

30. The computer-readable medium of claim 29 wherein the server comprises accounting software.

31. The computer-readable medium of claim 24 wherein the domain name is in a PENDINGDELETE status.
